(19) United States
(12) Patent Application Publication
(10) Pub. No.: US 2011/0187857 A1
(43) Pub. Date: Aug. 4, 2011

(54) Portable Data Management Device for Animals

(75) Inventor: Jason Peters, Condell Park (AU)

(73) Assignees: Elaine Medlicot, Newport (AU); Mr. Jason Peters, Condell Park (AU)

(21) Appl. No.: 12/817,163

(22) Filed: Jun. 16, 2010

(30) Foreign Application Priority Data
Feb. 2, 2010 (AU) 2010900398

(51) Int. Cl. H04N 7/18; G06F 12/00; B65D 81/02; A45F 5/00

(52) U.S. Cl. 348/143; 711/115; 206/521; 224/271; 711/E12.001; 348/E07.091

(57) ABSTRACT

A portable data management device (10) for an animal has electronic reader means for reading a microchip secured to the animal, an electronic camera (14, 16) for taking photographs, a screen (18) for visualizing data, and a key pad (20) for inputting data. The electronic camera is a built-in camera having a lens at a front of the device above the screen and key pad.

### TECHNICAL FIELD

The present invention relates to a portable data management device for animals. In particular, the invention relates to a portable electronic device that can store and organise a horse's medical history and other relevant data.

Although the background, objects and preferred embodiments of the invention will be hereinafter described with reference to a portable data management device for a horse, it is to be understood that the invention is not limited thereto but has wider application. For example, the portable data management device may be used for other domestic animals, such as farm production animals, pets and animals (like greyhounds) trained to compete in sporting events, as well as for wild animals involved in scientific testing or tracking.

It is to be understood that the terminology employed herein is for the purpose of description only and should not be regarded as limiting. For instance, the terms “comprising” or “comprises” are to be understood as meaning “including”, unless otherwise stated. Also, the term “data” is to be understood as including any information, whether or not it is of a technical nature, that can be used to create an electronic database for an animal.

### BACKGROUND ART

Microchips, implanted subcutaneously or intramuscularly, have been used for the identification of animals since the 1970s. The microchips used are passive in that they have no battery and are activated by energy received from a reader.

Once a microchip is implanted into an animal it cannot be easily removed or interfered with. Microchips suitable for the identification of animals are typically encoded with a unique non-reprogrammable number that can be read using a suitable reader within a fraction of a second. Provided the microchip number is registered on an accessible database, it is possible to very quickly and accurately establish the identity of a horse carrying the microchip at a racetrack, stud farm, training stable, animal shelter or at an auction venue.

Microchip readers typically have limited functionality, being unable to carry out functions beyond identification.

The present inventor has developed a portable device that includes a reader function and is able to store and organize a large amount of data of the animal beyond the capacity of prior art microchip readers.

### DISCLOSURE OF INVENTION

It is, therefore, an object of the present invention to overcome or substantially ameliorate the disadvantages and problems of the aforementioned prior art, or at least provide a useful alternative.

It is another object of the invention to provide a portable data management device that can read a microchip, can upload information about an animal's medical condition and history, and has a camera function.

It has been found by the present inventor that these and other objects of the invention may be achieved in general by providing a portable data management device for an animal, wherein the device comprises means for reading a microchip secured to the animal, means for taking photographs, a screen for visualizing data, and a key pad for inputting data.

Preferably, the device includes a USB port.

The means for taking photographs preferably comprises a built-in camera having a lens at a front of the device above the screen and key pad. The device is preferably housed in a shock resistant outer casing, and there is a strap at the rear of the casing for gripping by a hand or for engagement to a belt.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the conception, upon which the disclosure is based, may be readily utilized as the basis for designing other assemblies and processes for carrying out the objects of the present invention. It is important, therefore, that the broad outline of the invention described above be regarded as including such equivalent constructions in so far as they do not depart from the spirit and scope of the present invention.

### BRIEF DESCRIPTION OF THE DRAWINGS

The invention will be better understood and objects other than those set forth above will become apparent when consideration is given to the following detailed description thereof.

Such description makes reference to the accompanying drawings, in which:

FIG. 1 is a front view of a portable data management device according to a preferred embodiment of the invention,

FIG. 2 is a partial side view of the device of FIG. 1 showing the USB port, and

FIG. 3 is a rear view of the device of FIG. 1.

### MODES FOR CARRYING OUT THE INVENTION

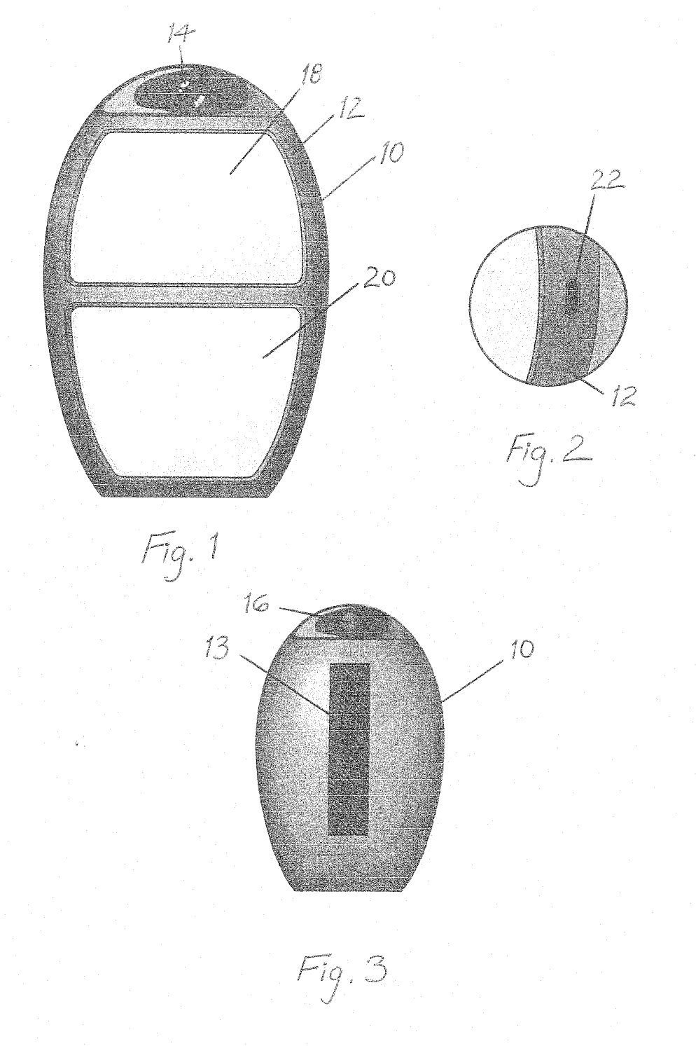

With reference now to the above summarized drawings of FIGS. 1 to 3, a portable data management device embodying the principles and concepts of the present invention and generally designated by the reference numeral 10 will now be described.

The device 10 has a generally oval shape and is of a size that allows it to be easily held by the hand. A shock resistant outer casing 12 provides a protective plastic housing for the device. There is a vertically oriented hand strap 13 or belt strap at the rear of the casing for gripping by a hand or for engagement to a belt.

The device 10, which is battery powered and is rechargeable, contains internalized electronic componentry dedicated to various functions. Although not shown, this componentry controls the function of a microchip reader, the function of a camera, the function of a screen, and the function of a key pad. A semiconductor chip within this componentry provides computer-like processing power based on preloaded software. The device could include a built-in hard drive.

A camera lens 14 is at the front of the device and a button 16 to operate the camera is at the rear.

A screen 18 for visualizing data is below the lens 14, and beneath the screen 18 is a key pad 20 for inputting data. The key pad 20 is an alphanumeric touch screen key pad.

A USB port 22 for enabling connection via a USB cable to a data input socket of a computer is provided at a side of the device. The device may also include wireless connection means to a computer.

In use, the device 10 reads (or scans) a microchip secured to an animal and the information on the microchip is uploaded onto the device. This information can subsequently be uploaded onto a computer and, if required, communicated via the internet to other users of the information.

The device 10 itself may be inputted with the following information: the animal's name, age, vaccination records, past medical conditions, origin and destination, dietary requirements, vices or habits, special needs, and owner's information. Any other information that the user believes may be useful can also be inputted onto the device, including photographic information taken with the camera regarding the animal's current appearance or condition.

It will be apparent to persons skilled in the art that the portable data management device may be made of many suitable materials.

It will also be readily apparent from the above that here are various advantages of the present invention.

One advantage is that, by using the portable data management device of the present invention, a person can make use of a microchip reader of expanded functionality, being unable to carry out a large number of functions beyond mere identification.

Still further advantages of the present invention will be apparent to persons skilled in the art.

It will also be readily apparent to persons skilled in the art that various modifications may be made in details of design and construction of the embodiments of the portable data management device, and in the steps of using the device described above, without departing from the scope or ambit of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. A portable data management device for an animal, comprising electronic reader means for reading a microchip secured to the animal, an electronic camera for taking photographs, a screen for visualizing data, and a key pad for inputting data.

2. The device of claim 1 and further including a USB port.

3. The device of claim 1 wherein the electronic camera comprises a built-in camera having a lens at a front of the device above the screen and key pad.

4. The device of claim 3 and further including a housing for he device, the housing comprising a shock resistant outer casing.

5. The device of claim 4 wherein there is a strap at the rear of the casing for gripping by a hand or for engagement to a belt.
